(19) United States
(12) Patent Application Publication
(10) Pub. No.: US 2006/0135202 A1
(43) Pub. Date: Jun. 22, 2006

(54) Method of transmitting fascimile over a mobile communication device

(75) Inventors: David Ho, Shanghai City (TW); Hai-Jun Wang, Shanghai City (TW)

Correspondence Address: BACON & THOMAS, PLLC, 625 SLATERS LANE, FOURTH FLOOR, ALEXANDRIA, VA, 22314, US

(73) Assignee: Inventec Applicances Corp., Taipei County (TW)

(21) Appl. No.: 11/205,996

(22) Filed: Aug. 18, 2005

(30) Foreign Application Priority Data
Dec. 7, 2004 (TW) 93137828

(51) Int. Cl. H04M 1/00

(52) U.S. Cl. 455/556.2

(57) ABSTRACT

The present invention provides a method of transmitting facsimile over a mobile communication device, capable of fast and effectively sending facsimile by wireless facsimile services, comprising the steps of: defining a data structure to set up a transmission format; editing a facsimile content to conform to the transmission format; verifying the GPRS authentication to start the communication service for data transmission; waiting to receive the response for successful transmission after the data have been transmitted, so as to confirm the completion of the operations, and finally disconnecting the GPRS service.

### FIELD OF THE INVENTION

The present invention relates to a method of transmitting facsimile, and more particularly to an improved method of transmitting facsimile over a mobile communication device.

### BACKGROUND OF THE INVENTION

Facsimile machines have a history of almost one century since it was invented in 1907. They are a type of data transmission tools, and due to their advantages of handiness, high speed, accuracy, and low price, they become indispensable communication tools for corporations and individuals.

The principle of transmitting facsimile is as follows: first scanning the contents on the paper into images, which are then transformed into a series of black and white dots, which are further transformed into audio signals, which are finally transmitted over telephone lines. After the recipient's facsimile machine has received these signals, it will then print these signals out, so that the recipient will receive a copy of the original facsimile document.

The facsimile equipment comprises: a facsimile machine; a fixed telephone line; a facsimile paper required for transmitting the facsimile; and a paper tray for printing the received data.

However, while using the facsimile machines, a lot of drawbacks are found inherent in facsimile machines as follows: (1) The price of facsimile machines is high and it is not convenient to use them; (2) They are not portable and not convenient to operate because the facsimile machines are fixed equipment; (3) Facsimile machines transmit facsimile over lines, so that they are required to be connected and transmitted via telephone lines; hence, it is not possible to achieve wireless transmission, and they are not capable of operating at any time, and are not convenient for the user to send and receive facsimiles at any time and at any place; (4) Facsimiles sent over facsimile machines are not able to be freely edited, modified, and adjusted, and moreover, can be sent to only one user, so that they are not capable of making group transmission; (5) It wastes a lot of papers to use facsimile machines, and the costs become higher especially for some corporations with busy operations.

In recent years, the penetration rate of mobile phones has constantly become record-breaking, and moreover, their capabilities also become stronger and stronger. Furthermore, various telecommunication service providers start to offer GPRS (General Packet Radio Service) service, which can transmit multimedia information such as voices, pictures, and texts at a rate of 160 kpbs. Hence, the present invention, based on the advantage of conveniently accessing the network over a mobile phone, together with the existing advantages of traditional facsimile machines, is aimed to provide the users with a more convenient way to transmit facsimile.

Just because of the advantages inherent in this, there will be a trend to use mobile phones for wireless transmission, which will compensate for the fixedness of facsimile machines and the disadvantages inherent in wire transmission and thus become a trend of wireless facsimile transmission.

### SUMMARY OF THE INVENTION

To overcome the abovementioned shortcomings, it is the primary object of the present invention to provide a method of achieving wireless facsimile transmission over a mobile communication device as a platform, together with the GPRS, over the TCP/IP (Transmission Control Protocol/Internet Protocol.)

To achieve the aforementioned objects of the present invention, the present invention provides a method of transmitting facsimile over a mobile communication device, comprising the steps of: defining a data structure to set up a transmission format; editing a facsimile content to conform to the transmission format; verifying the GPRS authentication to start the communication service for data transmission; waiting to receive the response for successful transmission after the data have been transmitted, so as to confirm the completion of the operations, and finally disconnecting the GPRS service.

The present invention further comprises the step of defining the data structure including the facsimile data, the designated facsimile number, the status of the designated facsimile number, the subscriber number of the mobile communication device, the subscriber number status of the mobile communication device and data length.

With the ever-rising utilization rate of mobile phones, the capabilities of mobile phones become greater and greater. Moreover, as existing technologies and related network equipment have become more developed, subscribers can achieve wireless facsimile transmission over a mobile phone by means of the present invention. The present invention can achieve facsimile transmission at any time and at any place over a mobile phone as a platform; secondly, group facsimile transmission can be made available to many people over a mobile phone; thirdly, the facsimile content can also be edited freely; fourthly, facsimile can be transmitted depending on one's personal preferences; fifthly, it can save the paper that is required for facsimile transmission over a facsimile machine and thus save unnecessary expenses; sixthly, it is cheaper to transmit facsimile by means of GPRS; seventhly, the operations are simple and speedy; finally, facsimile can be transmitted anonymously so that data transmission becomes confidential, safe, and reliable.

### BRIEF DESCIPTION OF THE DRAWINGS

The technical means adopted by the present invention to achieve the above and other objects can be best understood by referring to the following detailed description of the preferred embodiments and the accompanying drawings, wherein

FIG. 1 depicts a flowchart of the method of transmitting facsimile over a mobile communication device of the present invention.

FIG. 2 is a flowchart of Procedure 300 according to the method of transmitting facsimile over a mobile communication device of the present invention.

FIG. 3 is a flowchart of Procedure 400 according to the method of transmitting facsimile over a mobile communication device of the present invention.

FIG. 4 is a flowchart of Procedure 500 according to the method of transmitting facsimile over a mobile communication device of the present invention.

### DETAILED DESCRIPTION OF THE PREFERRED EMBODIMENTS

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

A more preferred embodiment of the present invention provides a method of achieving wireless facsimile transmission over a mobile communication device as a platform, together with the GPRS, over the TCP/IP (Transmission Control Protocol/Internet Protocol), wherein the mobile communication device can be a mobile phone, or a personal data assistant (PDA) that supports GPRS.

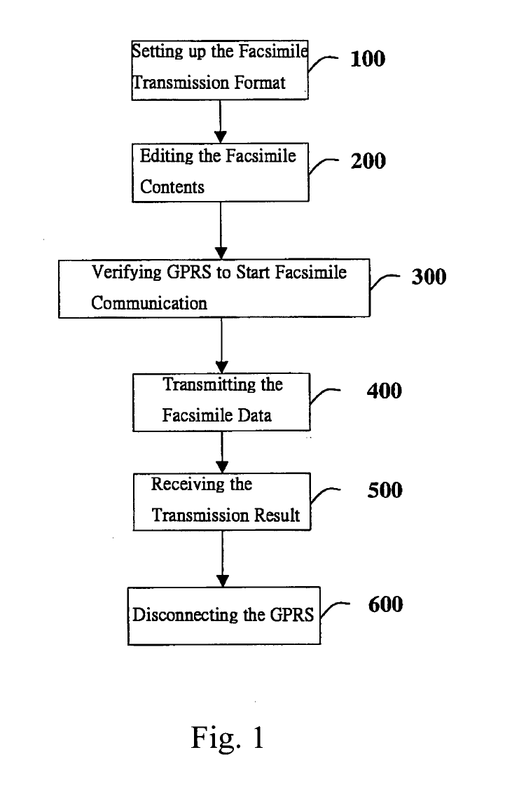

Please refer to FIG. 1, which depicts a flowchart of the method of transmitting facsimile over a mobile communication device of the present invention. The present invention comprises the following procedures:

Procedure 100: Setting up the transmission format

Setting up the transmission format of a mobile phone by firstly defining a data structure as shown in Table 1:

TABLE 1

| | | | | | |
|---|---|---|---|---|---|
| Fax | Other | Other Fax | Subscriber's | Subscriber's | Data |
| Data | Fax No. | Status | Mobile Phone | Fax Status | Length |
| | | | No. | | |

This data structure comprises: Fax Data, Other Fax No., Other Fax Status, Subscriber's Mobile Phone No., Subscriber's Fax Status, and Data Length, wherein Fax Data are the data of the facsimile content; Other Fax No. refers to the designated facsimile number to which the facsimile content is to be transmitted; Other Fax Status is generally “On” and operations can only be made only in the “On” status; Subscriber's Mobile Phone No. and Subscriber's Fax Status are convenient for the other (that is the recipient) to return a response automatically generated by the mobile phone system; Data Length is the length of the Fax Data.

Procedure 200: Editing the facsimile content

Conventionally, the principle of transmitting facsimile is as follows: first scanning the contents on the paper into images, so as to obtain related facsimile data, which are then transmitted. As the present invention transmits facsimile over a mobile phone, this step can be obviated. Moreover, subscribers freely edit their favorite facsimile contents by means of the input interface of the mobile phone, for example, through imaging by the digital lens of the mobile phone, or inputting alphanumeric parts of the facsimile contents by buttons.

The mobile phone then codes the facsimile contents according to the facsimile format. In this coding process, the width and height of the facsimile contents will be adjusted to the size commonly found in ordinary paper, e.g. the size of A4 paper. In this way, it is free from the restriction and inconvenience caused by the size of the screen of the mobile phone.

Procedure 300: Verifying GPRS to start facsimile communication

The subscriber connects to the GPRS service through a mobile phone to start the communication protocol and then prepare for transmitting facsimile data.

Procedure 400: Transmitting the facsimile data

The subscriber can transmit facsimile data to the designated facsimile number via a mobile phone, only after the mobile phone has been authorized by telecommunication network.

Procedure 500: Receiving the transmission result

After the facsimile data have been transmitted, the mobile phone waits for the response of facsimile transmission from the device holding the designated facsimile number, and then displaying a prompt on the screen of the mobile phone to show whether the facsimile transmission result is successful or unsuccessful.

Procedure 600: Disconnecting the GPRS

Finally, the mobile phone disconnects the GPRS service and completes the facsimile transmission of the present invention. Moreover, the related parameters of the mobile phone will be automatically cleared to prepare for the next facsimile transmission.

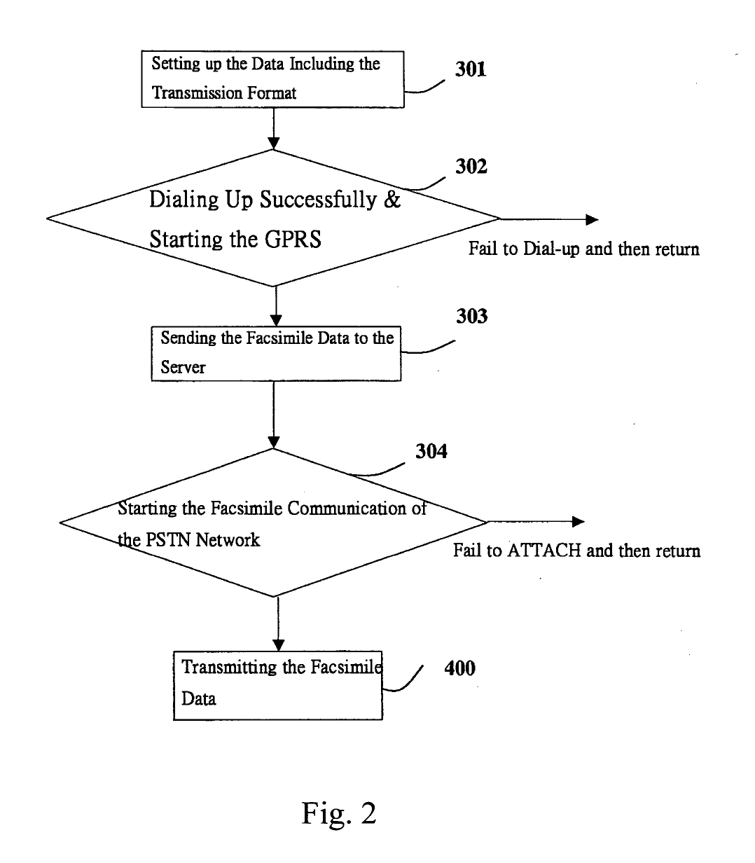

Please refer to FIG. 2, which depicts a flowchart of Procedure 300 according to the method of the present invention as shown in FIG. 1. Procedure 300 of verifying GPRS to start facsimile communication according to the method of the present invention comprises the steps of:

Step 301: Setting up the facsimile data comprising the transmission format based on the above data structure by editing the facsimile contents and then preparing for facsimile transmission.

Step 302: The mobile phone starts to dial up so as to start the GPRS service. If the dial-up is not successful, then return to the main menu of the mobile phone, and then prompt for the “unsuccessful dial-up” message of the mobile phone; if the dial-up is successful, then this means that the mobile phone has successfully entered the GPRS service, and the server of the GPRS telecommunication system will then prepare for receiving the facsimile data transmitted by the mobile phone. The request issued by the mobile phone will only be authorized, once the registry and authentication of the GPRS service have been completed. Then only with this authorization, the mobile phone has the right to proceed with the next operation. Afterwards, the GPRS telecommunication system will determine the facsimile format of the head of the facsimile data (that is the data head) transmitted, so as to verify whether it is legitimate, and the legitimacy so verified is protected and accredited by the communication protocol. Only through the authorization of the GPRS service, can the facsimile data be transmitted safely and reliably to the subscriber-designated facsimile number; otherwise, it is not possible to achieve facsimile transmission via a mobile phone.

Step 303: After the mobile phone confirms that the GPRS service has been started, transmit the facsimile data to the server of the GPRS telecommunication system.

Step 304: The server will start the facsimile transmission of the PSTN network (Public Switched Telephone Network). If the ATTACH command fails, return to the mobile phone and prompt for the “unsuccessful ATTACH command” message; if successful, enter Procedure 400 to execute the transmission of facsimile data.

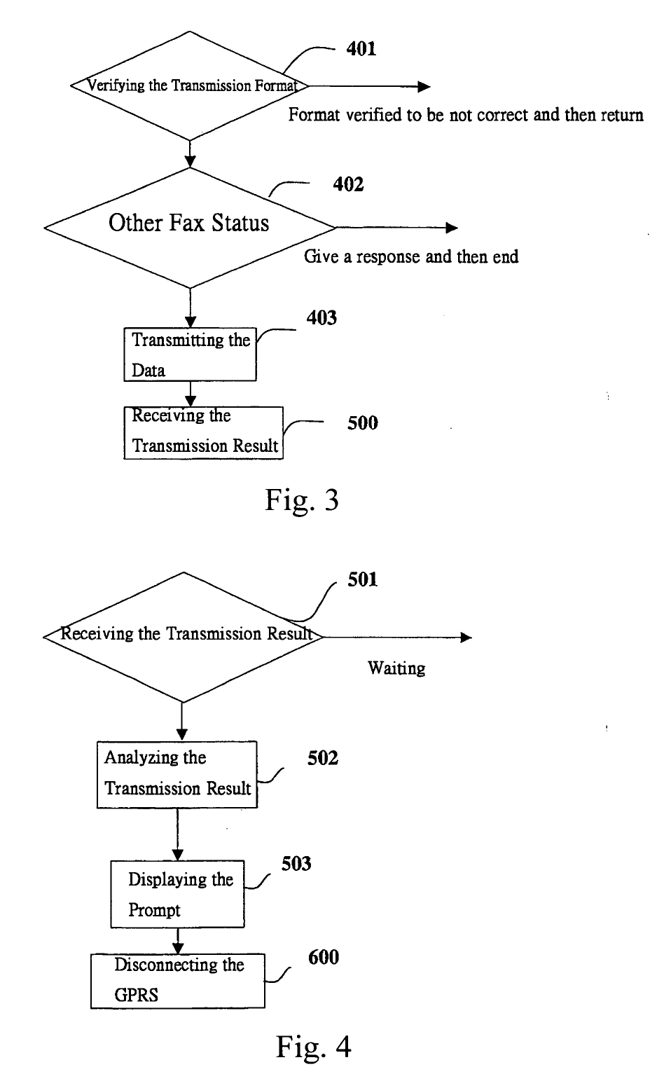

Please refer to FIG. 3, which depicts a flowchart of Procedure 400 according to the method of the present invention as shown in FIG. 1. Procedure 400 of transmitting the facsimile data according to the method of the present invention comprises the steps of:

Step 401: Prior to the data transmission, first verify the facsimile format, and if the format is not correct, then request the mobile phone for providing facsimile data again.

Step 402: After the facsimile format has been verified “correct”, confirm if Other Fax Status is “ON”. If Other Fax Status is not “ON” (e.g. if the line is busy or the machine is off), then the mobile phone gives a response to report “Other Fax Status” and terminate the operations.

Step 403: After having confirmed that Other Fax Status is “ON”, start to transmit the facsimile data, until all the facsimile data have been transmitted. Then enter Procedure 500 to receive the transmission result.

Please refer to FIG. 4, which depicts a flowchart of Procedure 500 according to the method of the present invention as shown in FIG. 1. Procedure 500 of receiving the transmission result according to the method of the present invention comprises the steps of:

Step 501: After the Procedure 400 of transmitting the facsimile data has been completed, the communication is still in progress, and the mobile phone will continue to wait for the transmission result responded by Other Fax.

Step 502: After the mobile phone has received the transmission result, analyze if the transmission result is successful or unsuccessful.

Step 503: The mobile phone will display the analysis of the transmission result and then prompt for an icon or a text on the screen of the mobile phone. Finally, execute Procedure 600 of disconnecting the GPRS.

While the invention has been described by way of examples and in terms of preferred embodiments, it is to be understood by those who are familiar with the prior art that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures.

What is claimed is:

1. A method of transmitting facsimile over a mobile communication device, comprising the steps of:
defining a data structure to set up a transmission format;
editing a facsimile content to conform to said transmission format;
verifying the GPRS authentication to start the public switched telephone network (PSTN) communication;
transmitting facsimile data of said transmission format to a designated facsimile number; and
receiving a transmission result and then displaying a corresponding prompt.

2. The method of transmitting facsimile over a mobile communication device as claimed in claim 1, comprising the step of defining said data structure including said facsimile data, said designated facsimile number, the status of said designated facsimile number, the subscriber number of said mobile communication device, the subscriber number status of said mobile communication device and data length.

3. The method of transmitting facsimile over a mobile communication device as claimed in claim 1, comprising the step of editing a facsimile content so as to adjust the width and height of the facsimile content to the size of A4 paper.

4. The method of transmitting facsimile over a mobile communication device as claimed in claim 1, comprising the step of generating said facsimile content by means of an imaging function of said mobile communication device.

5. The method of transmitting facsimile over a mobile communication device as claimed in claim 1, comprising the step of generating said facsimile content by means of a messaging interface of said mobile communication device.

6. The method of transmitting facsimile over a mobile communication device as claimed in claim 1, comprising the step of displaying the corresponding prompt of said transmission result on the screen of said mobile communication device.

7. The method of transmitting facsimile over a mobile communication device as claimed in claim 1, comprising the step of disconnecting the GPRS service once the transmission result has been received.

8. The method of transmitting facsimile over a mobile communication device as claimed in claim 1, comprising the step of executing the GPRS ATTACH command to confirm that it has been successfully logged in and then dialing said designated facsimile number.
